(19) United States
(12) Patent Application Publication
(10) Pub. No.: US 2014/0136575 A1
(43) Pub. Date: May 15, 2014

(54) LOG-STRUCTURED GARBAGE COLLECTION

(71) Applicants: Yuanyuan Zhao, Edison, NJ (US); Per Brashers, Oakland, CA (US)

(72) Inventors: Yuanyuan Zhao, Edison, NJ (US); Per Brashers, Oakland, CA (US)

(21) Appl. No.: 13/674,021

(22) Filed: Nov. 10, 2012

(51) Int. Cl. G06F 17/30

(52) U.S. Cl. CPC G06F 17/30303
USPC 707/813

(57) ABSTRACT

System and method for log-structured garbage collection are provided. In particular, some embodiments use write pointer to read pointer offsets to enable reclamation of space within a log-structured storage medium (e.g., sequential forward only write mechanisms such as SSD, Tape, Shingled Drives, Flash Drives, etc.). These techniques allow the garbage collection system to reclaim space without copying data from one storage medium to another. Instead of copying the data, various embodiments reset the write and read pointers. In addition, different retention policies can be easily enforced while allowing for efficient garbage collection. For example, in a backup storage, each log-structured media can be designated with a retention time and only allow workloads with the specified retention time to be stored. As a result, the garbage collection incurs only read pointer movements.

### TECHNICAL FIELD

Various embodiments of the present invention generally relate to garbage collection. More specifically, various embodiments of the present invention relate to systems and methods for log-structured garbage collection.

### BACKGROUND

Garbage collection is a form of automatic storage management which allows for portions of storage occupied with objects that are no longer referenced to be reclaimed. There are many techniques for identifying storage areas or storage blocks which can be reclaimed. For example, reference counting may be used to count references to an object stored in a storage location. As a result, objects having a reference count of zero may be considered garbage since there are no references to those objects.

Due to the automatic nature of most garbage collection routines, there is some computational overhead which can reduce the availability of system resources for other processes. In addition, in many types of traditional garbage collection the content of any storage or storage block that is not being reclaimed is copied to another location. This results in additional system resources being consumed. As such, there are a number of challenges and inefficiencies found in traditional garbage collection algorithms.

### SUMMARY

Systems and methods are described for providing garbage collection. More specifically, various embodiments of the present invention relate to systems and methods for log-structured garbage collection. In some embodiments, a method can include sequentially writing data (e.g., log data) associated with write requests to a storage media (e.g., disk drive, a flash drive, a tape drive, a heat-assisted magnetic recording drive, or a patterned media). When the end of the storage media is reached, the data can be written to the beginning of the storage media to allow for circular writes. In some embodiments, the data may be associated with a retention or expiration policy indicating that the data should only be kept for a specified time period (e.g., 90 days).

Each write can start at a location on the storage media indicated by a write pointer. Upon completion of the write, the write pointer may be updated to indicate an updated location on the storage media where data associated with the next write request should be written. A read pointer is also maintained that indicates a read location logically located before the location of the write pointer. The data stored on the storage media between the read pointer and the write pointer is protected and can only be read in some embodiments. In one or more embodiments, the data located logically before the read pointer cannot be read. Garbage collection and writes are allowed on portions of the storage media located before the read pointer and after the write pointer.

Upon compliance with the expiration policy, the read pointer can be advanced (e.g., brought forward) to auto-expire the data. In some cases, before bringing the read pointer forward to auto-expire the data, a determination can be made if any data located on the storage media between the read pointer and the write pointer has a hold to prevent auto-expiration of the data. When the hold has been detected, the data with the hold can be copied to a second storage media before bringing the read pointer forward. In other cases, the data can be copied to the same storage media at the location pointed to by the current write pointer.

In some embodiments, a minimum buffer space between the write pointer and the read pointer can be determined. The minimum buffer space can be maintained between the read pointer and the write pointer. The minimum buffer space may be specified by the manufacturer or by properties of the storage media. For example, the storage media may be a flash drive and the minimum buffer space an erase block of the flash drive.

Embodiments of the present invention also include computer-readable storage media containing sets of instructions to cause one or more processors to perform the methods, variations of the methods, and other operations described herein.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Embodiments of the present invention will be described and explained through the use of the accompanying drawings in which:

FIG. 1 illustrates an example of a networked-based environment in which some embodiments of the present invention may be utilized;

FIG. 2 shows a block diagram with components of a storage system in accordance with one or more embodiments of the present invention;

FIGS. 3A-3C illustrate the use of a read pointer and a write pointer in accordance with various embodiments of the present invention;

FIG. 4 is a flowchart with a set of operations that allow for the auto-expiration of data in accordance with some embodiments of the present invention;

FIG. 5 is a flowchart with a set of operations for storing data on a storage media in accordance with various embodiments of the present invention;

FIG. 6 is a flowchart with a set of operations for ensuring the retention of data to comply with a data hold in accordance with some embodiments of the present invention; and

FIG. 7 illustrates an example of a computer system with which some embodiments of the present invention may be utilized.

The drawings have not necessarily been drawn to scale. For example, the dimensions of some of the elements in the figures may be expanded or reduced to help improve the understanding of the embodiments of the present invention. Similarly, some components and/or operations may be separated into different blocks or combined into a single block for the purposes of discussion of some of the embodiments of the present invention. Moreover, while the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Various embodiments of the present invention generally relate to garbage collection. More specifically, various embodiments of the present invention relate systems and methods for log-structured garbage collection. Some embodiments use write pointer to read pointer offsets to enable reclamation of space within a log-structured storage medium (e.g., sequential forward only write mechanisms such as SSD, tape, shingled drives, flash drives, etc.). These techniques allow the garbage collection system to reclaim space without copying data from one storage medium to another.

Instead of copying the data, various embodiments reset the write and read pointers to indicate which sections of the storage media are protected and which can be reclaimed. In addition, different retention policies can be easily enforced while allowing for efficient garbage collection. For example, in a backup storage, each log-structured media (such as a shingled drive) can be designated with a retention time and only allow workloads with the specified retention time to be stored on the log-structured media. Consequently, efficient garbage collection may be performed in log-structured file systems which incur only read pointer movements. Resetting the read pointer makes garbage collection a simple task and allows for easy enforcement of retention policies. By designating different retention times across multiple shingled media in storage node or in a RAIL configuration, different data sets may also be retained independently.

In some embodiments, when the read pointer is moved to allow for a significant portion of the data to be deleted (freeing space), any valid data from the space marked for reclamation may be copied into a space that is still valid. This technique can be effective for reclamation of space that does not have a retention policy. As a result, this can be viewed as a compaction process.

While, for convenience, embodiments of the present invention are described with reference to storage media, embodiments of the present invention are equally applicable to any type of memory or circular logs. In addition, the techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

### Terminology

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary channels or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to various embodiments,” “in the embodiments shown,” “in other embodiments,” and the like generally mean that the particular feature, structure, or characteristic following the phrase is included in at least one embodiment of the present invention and may be included in more than one embodiment of the present invention. In addition, such phrases do not necessarily refer to the same embodiments or to different embodiments.

If the specification states a component or feature “may,” “can,” “could,” or “might” be included or have a characteristic, that particular component or feature is not required to be included or have the characteristic.

The term “module” refers broadly to software, hardware, or firmware (or any combination thereof) components. Modules are typically functional components that can generate useful data or other output using specified input(s). A module may or may not be self-contained. An application program (also called an “application”) may include one or more modules, or a module can include one or more application programs.

### General Description

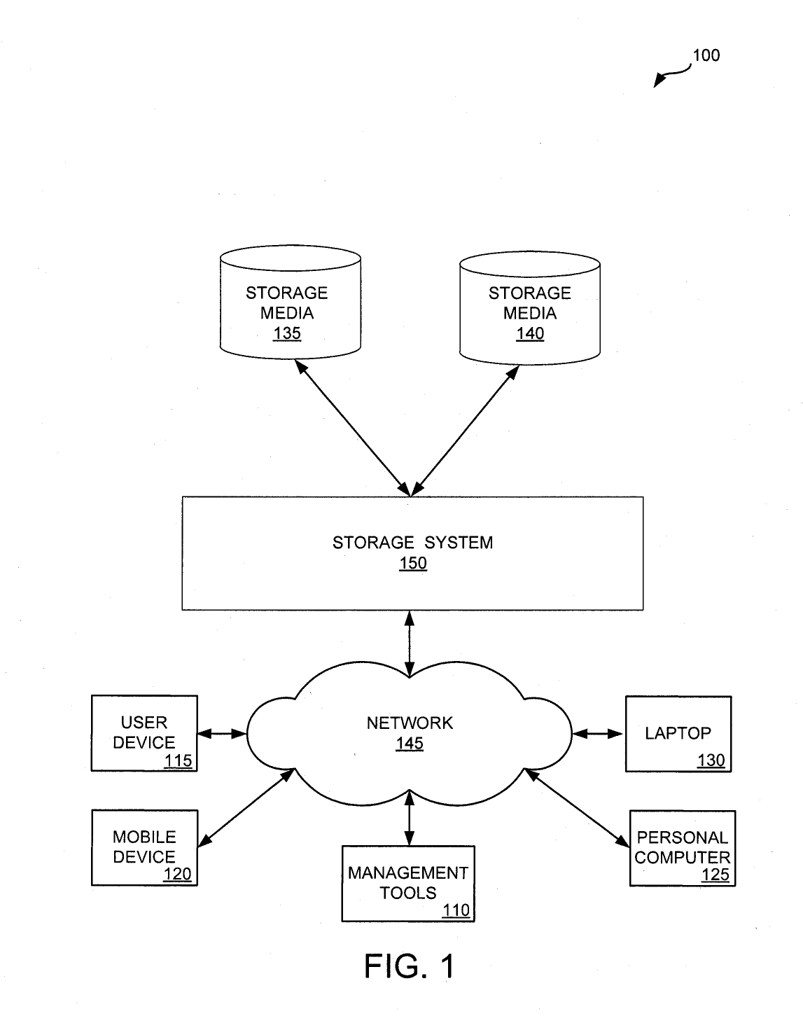

FIG. 1 illustrates an example of a networked-based environment 100 in which some embodiments of the present invention may be utilized. Companies can store a tremendous amount of data (e.g., photographs, messages, e-mails, electronic documents, or healthcare records) and related analytics (e.g., usage analytics). In some cases, the data can be write-mostly workloads (e.g., log data). The data may be generated automatically through various activity recording mechanisms. In some cases, the automatically recorded data may be used for measuring compliance with service level objects, compliance with legal requirements, or for future usage analysis. Various embodiments use storage system 150 to manage the storage of the data.

Some data can be submitted through various management tools 110, user devices 115, mobile devices 120, personal computers 125, laptops 130, and/or other devices to allow the data to be stored on one or more databases 135 and 140. As illustrated in FIG. 1, these devices and tools may use network 145 to submit and retrieve information from the storage media 135 and 140. Various embodiments of the present invention use storage system 150 to manage the access the users (both end-users and employees) have to the information and data stored on storage media 135 and 140 (e.g., tape drive, solid-state storage device, hybrid storage servers, and other temporary or permanent storage media).

User device 115 can be any computing device capable of receiving user input as well as transmitting and/or receiving data via the network 145. In one embodiment, user device 115 is a conventional computer system, such as a desktop 125 or laptop computer 130. In another embodiment, user device 115 may be mobile device 120 having computer functionality, such as a personal digital assistant (PDA), mobile telephone, smart-phone or similar device. User device 115 is configured to communicate with storage system 150, and/or the financial account provider via the network 145. In one embodiment, user device 115 executes an application allowing a user of user device 115 to interact with the storage system 150. For example, user device 115 can execute a browser application to enable interaction between the user device 115 and storage system 150 via the network 145. In another embodiment, user device 115 interacts with storage system 150 through an application programming interface (API) that runs on the native operating system of the user device 115, such as IOS® or ANDROID™.

User devices 115 can be configured to communicate via the network 145, which may comprise any combination of local area and/or wide area networks, using both wired and wireless communication systems. In one embodiment, network 145 uses standard communications technologies and/or protocols. Thus, network 145 may include links using technologies such as Ethernet, 802.11, worldwide interoperability for microwave access (WiMAX), 3G, 4G, CDMA, digital subscriber line (DSL), etc. Similarly, the networking protocols used on network 145 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over network 145 may be represented using technologies and/or formats including hypertext markup language (HTML) or extensible markup language (XML). In addition, all or some links can be encrypted using conventional encryption technologies such as secure sockets layer (SSL), transport layer security (TLS), and Internet Protocol security (IPsec).

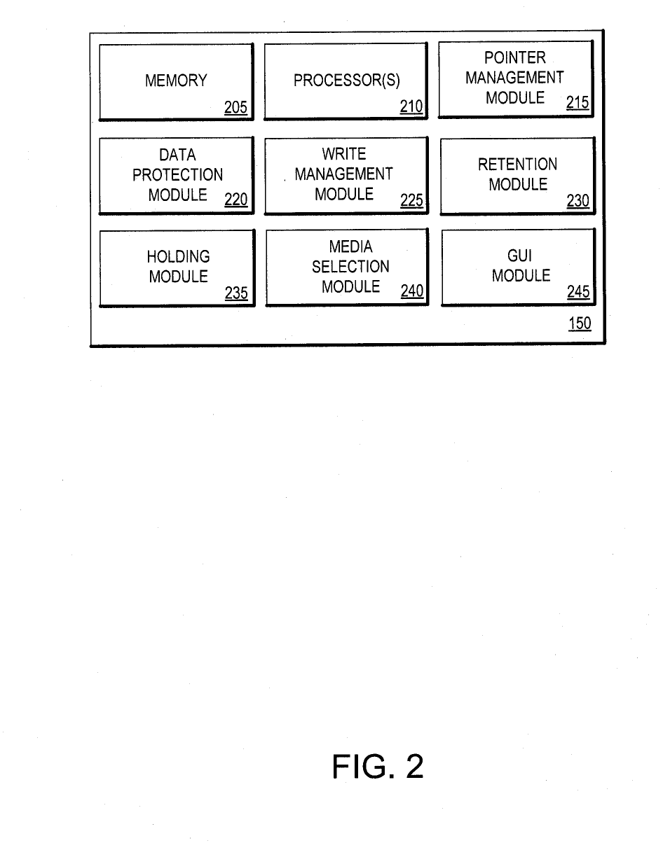

FIG. 2 shows a block diagram with components of storage system 150 in accordance with one or more embodiments of the present invention. According to the embodiments shown in FIG. 2, the system can include memory 205, one or more processors 210, pointer management module 215, data protection module 220, write management module 225, retention module 230, holding module 235, media selection module 240, and graphical user interface (GUI) module 245. Other embodiments of the present invention may include some, all, or none of these modules and components along with other modules, applications, and/or components. Still yet, some embodiments may incorporate two or more of these modules into a single module and/or associate a portion of the functionality of one or more of these modules with a different module. For example, in one embodiment, data protection module 220 and write management module 225 can be combined into a single module for managing write requests to the storage media.

Memory 205 can be any device, storage media, mechanism, or populated data structure used for storing information. In accordance with some embodiments of the present invention, memory 205 can encompass any type of, but is not limited to, volatile memory, nonvolatile memory, and dynamic memory. For example, memory 205 can be random access memory, memory storage devices, optical memory devices, magnetic media, floppy disks, magnetic tapes, hard drives, SIMMs, SDRAM, DIMMs, RDRAM, DDR RAM, SODIMMS, erasable programmable read-only memories (EPROMs), electrically erasable programmable read-only memories (EEPROMs), compact disks, DVDs, and/or the like. In accordance with some embodiments, memory 205 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 205.

Memory 205 may be used to store instructions for running one or more applications or modules on processor(s) 210. For example, memory 205 could be used in one or more embodiments to house all or some of the instructions needed to execute the functionality of pointer management module 215, data protection module 220, write management module 225, retention module 230, holding module 235, media selection module 240, and/or graphical user interface module 245. In addition, memory 205 may be used for storing data (e.g., log data).

Pointer management module 215 can be configured to maintain a write pointer and a read pointer for a storage media. The write pointer includes a current write location for the storage media. The read pointer indicates a current read location associated with the storage media. In some embodiments, a read sent to a logical address lower than the read pointer address may be rejected as an invalid region access. As data is written to the storage media, the write pointer can be updated to point to an updated location. If the end of the drive has been reached, the updated location may wrap around to the beginning of the drive.

In some cases, the storage media may need a minimum buffer space between the read pointer and the write pointer. The pointer management module can be configured to keep the current write location and current read location separated by at least the minimum buffer space in various embodiments. For example, the storage media may be a flash drive and the minimum buffer space an erase block of the flash drive. While the minimum separation space is defined by the manufacturer of the storage media or by properties of the storage media, a larger buffer space of an arbitrary size can be used as the minimum buffer space in some embodiments. This larger size could be specified by an application backup or by the data-lifecycle.

Data protection module 220 can be configured to protect data located between the current read location pointer and the current write location pointer. In accordance with various embodiments, data protection module may not allow writes between the current read location pointer and the current write location pointer. Reads of this data, however, may be allowed in various embodiments. The data may be protected in a variety of ways. For example, data protection module 220 may modify metadata associated with the data between the current read location pointer and the current write location pointer. The metadata may indicate that the data cannot be deleted. As another example, data protection module 220 may use the current read location pointer and the current write location pointer as a hard and fast block range effectively masking off the area. Still yet, data protection module 220 may encrypt some of the data to prevent access and modification.

Write management module 225 may be configured to receive write requests, identify the current write location, and write data associated with the write request to the storage media. As a result, the data associated with the write requests may be sequentially added to the storage media. In some embodiments, the data being written to the storage media is data that is infrequently accessed (e.g., log data). The data may have a retention or expiration policy which indicates that the data should only be kept for a specified time period or range (e.g., ninety days, at least ninety days, or less than one hundred days). Retention module 230 can be used to manage the retention policy associated with the data and/or storage media.

In some embodiments, a hold request (e.g., a legal hold) may be placed on the data stored on the storage media. Holding module 235 can be configured to receive and process the hold request. The hold request may include a hold retention policy. The hold request may also identify a portion of the data to hold or may specify properties of the data to hold. For example, a hold request may indicate that all e-mails from a specific person need to be held. As such, holding module 235 can receive the hold request and identify all e-mails from the specific person. Holding module 235 can also copy the identified data to a second storage media where the data may be held in accordance with the hold policy. One advantage of transferring the data to a second storage media is that this allows the auto-expiration and simple garbage collection on the original storage media.

For out of order deletions from the storage media, storage system 150 may have additional sets of policies or algorithms which reclaim the space. The time between deletion and garbage collection could be application managed in some cases. Write management module 225 may also be used in some embodiments to enforce the inaccessibility of the data located between the read pointer and the write pointer. For example, write management module 225 may use encryption and provide for the destruction of the encryption key.

Media selection module 240 may be configured to receive incoming write requests and select the storage media from the plurality of storage media based on an expiration or retention policy. Media selection module may also use other properties of the data instead of, or in addition to the retention policy. For example, media selection module may identify certain types of data (e.g., legal data) and select the storage media based, at least in part, on that identification. In addition, in various embodiments, media selection module 240 may be used to select the second storage media where data with a hold can be transferred.

GUI module 245 can be used to generate one or more graphical user interface screens. These screens can be used to display information (e.g., data retention policies and compliance metrics) to users. In some embodiments, the graphical user interface screens can be used by the users to define or select the retention policies associated with various data. In some embodiments, GUI module 245 may generate a graphical user interface screen providing a notification to a user for data that does not fit any of the pre-set retention periods. This screen may also request for a manual override of the pre-set retention period for that data.

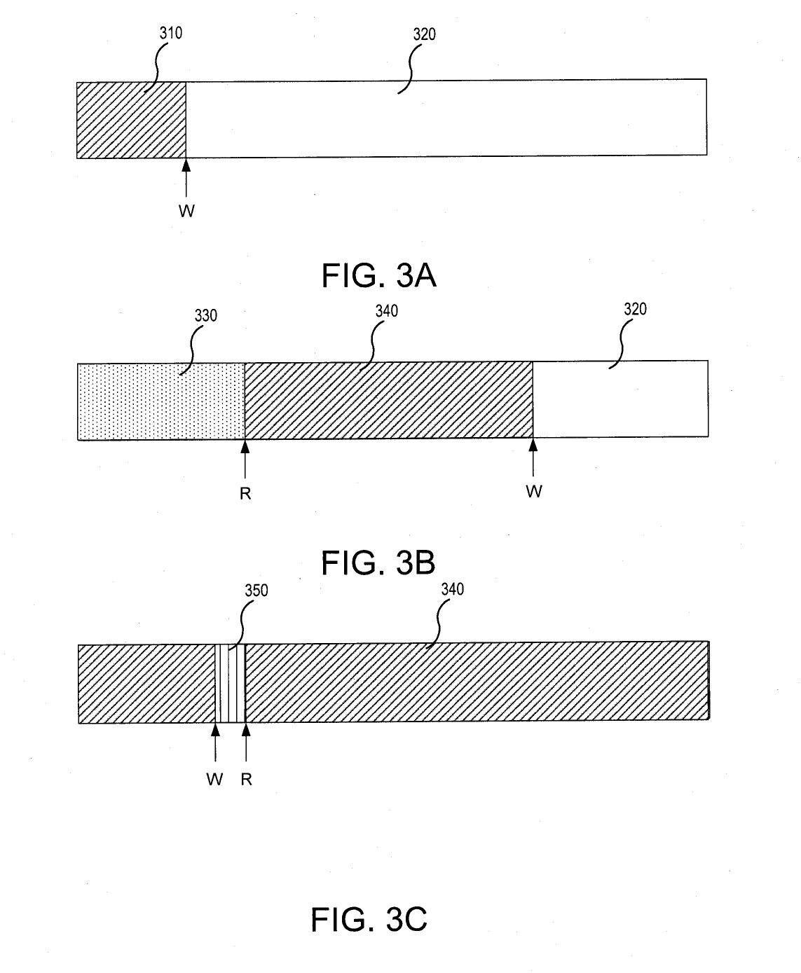

FIGS. 3A-3C illustrate the use of a read pointer and a write pointer in accordance with various embodiments of the present invention. FIG. 3A represents a storage media which has data stored in portion 310. The portion of the storage media represented by 320 is free space. The letter “W” represents the current write location of a write pointer. FIG. 3B illustrates the state of the storage media at a subsequent time, where a current read location of the read pointer is represented by the letter “R.” The data in portion 330 is available for reclamation. The data in portion 340 is protected data that cannot be erased. The portion of the storage media represented by 320 is free and available for the writing of data. When the data is sequentially written to the storage media and as the retention period expires, the current location of the read pointer may be advanced to the right.

FIG. 3C illustrates the state of the storage media subsequent to the state shown in FIG. 3B. As illustrated in FIG. 3C, the current location of the write pointer (“W”) wraps around the end of the storage media with the subsequent writes. In the scenario illustrated, the retention period has not passed for any of the protected data in portion 340. As a result, the current location of the read pointer stays the same as in FIG. 3B. Section 350 represents the minimum buffer size that is being maintained between the write pointer and the read pointer. In accordance with various embodiments, the minimum buffer size may be greater than or equal to zero.

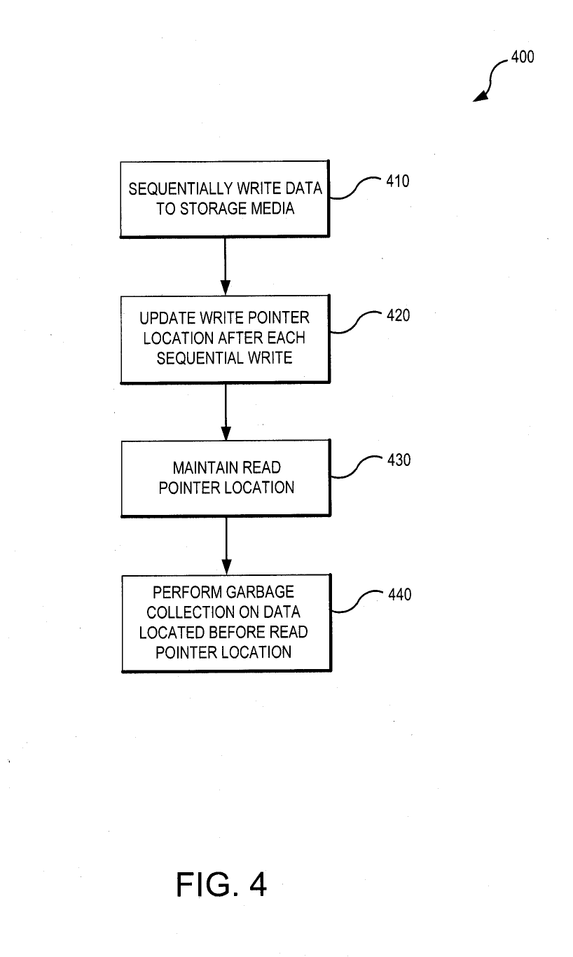

FIG. 4 is a flowchart with a set of operations 400 that allow for the auto-expiration of data in accordance with some embodiments of the present invention. The operation illustrated in FIG. 4 may be performed by one or more modules (e.g., pointer management module 215 and/or write management module 225) and/or one or more components such as processor(s) 210. Writing operation 410 sequentially writes data to a storage media. The write pointer location can be updated after each sequential write by update operation 420. Maintenance operation 430 maintains the read pointer location (e.g., based on expiration of a time period defined by a retention policy). For example, in some embodiments the data is written sequentially to the storage media and has a uniform expiration period. As a result, the read pointer location will only have to be advanced once the time period has expired. As the read pointer location is advanced, garbage collection operation 440 can be used to reclaim space on the storage media located before the read pointer location.

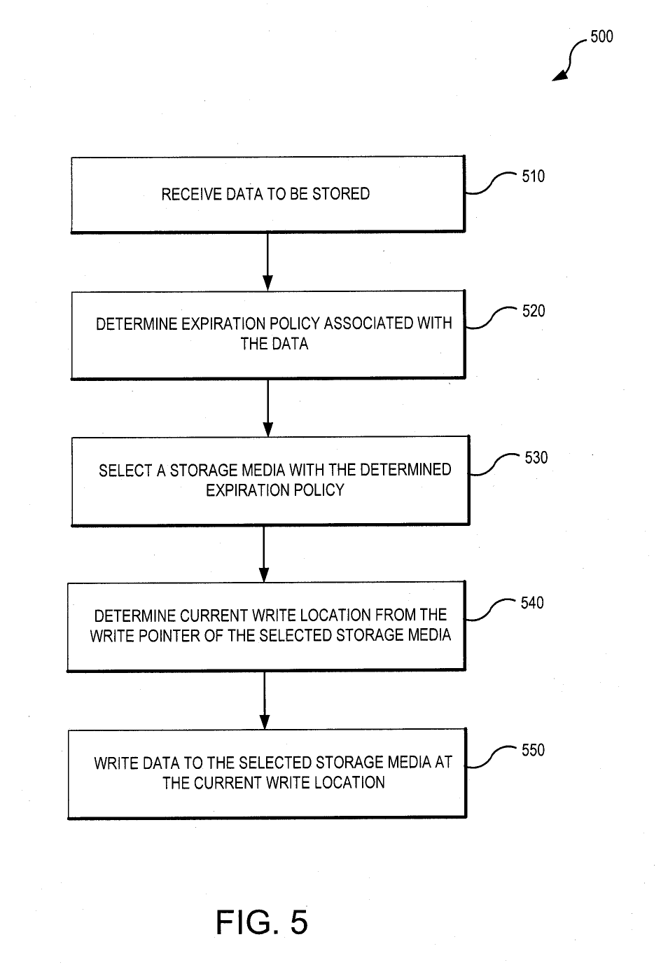

FIG. 5 is a flowchart with a set of operations 500 for storing data on a storage media in accordance with various embodiments of the present invention. The operation illustrated in FIG. 5 may be performed by pointer management module 215, write management module 225, retention module 230, media selection module 240 and/or one or more components such as processor(s) 210. As illustrated in FIG. 5, receiving operation 510 receives data to be stored. Policy determination operation 520 determines an expiration policy associated with the data. For example, in some embodiments, the expiration policy may indicate the number of days the data should be kept by the storage system. This expiration policy information may be included, for example, in a header, within a write request, an attached message, associated with an originating device, etc. In other cases, the expiration policy may be associated with characteristics of the data through a set of rules. As a result, policy determination 520 may identify the retention policy by determining the characteristics of the data and applying the set of rules.

Media selection operation 530 uses the expiration policy to select a storage media on which to store the data. In some embodiments, media selection operation 530 may use other factors to select the storage media. For example, media selection operation may use information about the data (e.g., data size, origination, content, etc.), current storage media utilization, network availability, service level objectives, and/or other factors. Once the storage media has been selected, location determination operation 540 determines the current write location from the write pointer of the selected storage media. Then, writing operation 550 writes the data to the selected storage media at the current write location.

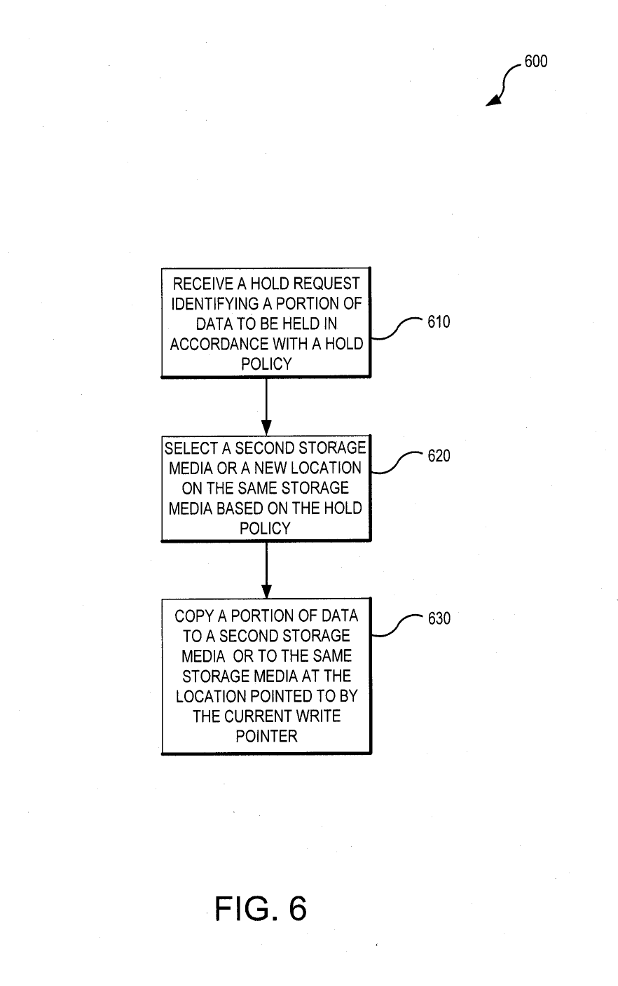

FIG. 6 is a flowchart with a set of operations 600 for ensuring the retention of data to comply with a data hold in accordance with some embodiments of the present invention. The operation illustrated in FIG. 6 may be performed by one or more modules or components such as holding module 235 and/or processor(s) 210. As illustrated in FIG. 6, receiving operation 610 receives a hold request. The hold request may identify a portion of the data to be held in accordance with a hold policy. In some embodiments, the hold request may also specify various features (e.g., time period, author, document type, etc.) for identifying data on a storage media which needs to be held. Selection operation 620 selects a second storage media or a new location (e.g., at the location pointed to by the current write pointer) on the same storage media based on the hold policy. Once the second storage media is selected, the portion of the data identified by the hold request may be copied using copy operation 630. In other cases, operation 630 may copy the data to the same storage media at the location pointed to by the current write pointer. As a result, the read pointer location and garbage collection may continue as normal on the original storage media.

### Exemplary Computer System Overview

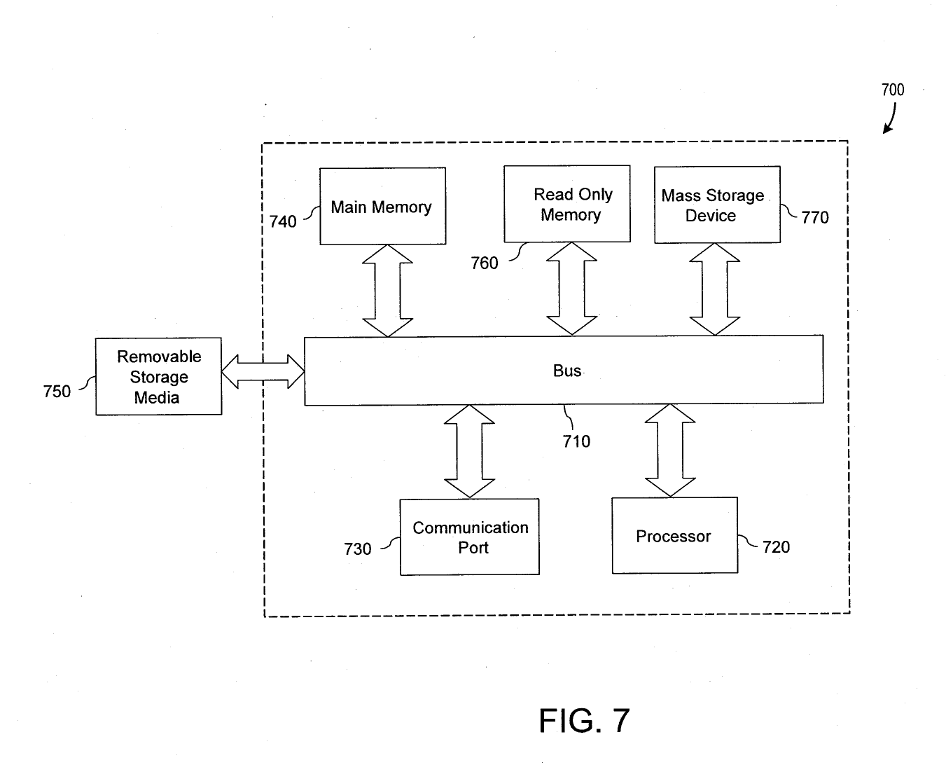

Embodiments of the present invention include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 7 is an example of a computer system 700 with which embodiments of the present invention may be utilized. According to the present example, the computer system includes a bus 710, at least one processor 720, at least one communication port 730, a main memory 740, a removable storage media 750, a read only memory 760, and a mass storage device 770.

Processor(s) 720 can be any known processor, such as, but not limited to, an Intel® Itanium® or Itanium 2® processor(s); AMD® Opteron® or Athlon MP® processor(s); or Motorola® lines of processors. Communication port(s) 730 can be any of an RS-232 port for use with a modem-based dialup connection, a 10/100 Ethernet port, or a Gigabit port using copper or fiber. Communication port(s) 730 may be chosen depending on a network such as a Local Area Network (LAN), Wide Area Network (WAN), or any network to which the computer system 700 connects.

Main memory 740 can be Random Access Memory (RAM) or any other dynamic storage device(s) commonly known in the art. Read only memory 760 can be any static storage device(s) such as Programmable Read Only Memory (PROM) chips for storing static information such as instructions for processor 720.

Mass storage device 770 can be used to store information and instructions. For example, hard disks such as the Adaptec® family of SCSI drives, an optical disc, an array of disks such as RAID, such as the Adaptec family of RAID drives, or any other mass storage devices may be used.

Bus 710 communicatively couples processor(s) 720 with the other memory, storage and communication blocks. Bus 710 can be a PCI/PCI-X or SCSI based system bus depending on the storage devices used.

Removable storage media 750 can be any kind of external hard-drives, floppy drives, IOMEGA® Zip Drives, Compact Disc-Read Only Memory (CD-ROM), Compact Disc-Re-Writable (CD-RW), and/or Digital Video Disk-Read Only Memory (DVD-ROM).

The components described above are meant to exemplify some types of possibilities. In no way should the aforementioned examples limit the scope of the invention, as they are only exemplary embodiments.

In conclusion, the present invention provides novel systems, methods and arrangements for garbage collection. While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations that fall within the scope of the claims, together with all equivalents thereof. Therefore, the above description should not be taken as limiting the scope of the invention, which is defined by the appended claims.

What is claimed is:

1. A method comprising:
sequentially writing data associated with write requests to a storage media, wherein each write starts at a location on the storage media indicated by a write pointer;
updating, upon completing each write, the write pointer to indicate an updated location on the storage media where data associated with the next write request should be written;
maintaining a read pointer logically located before the write pointer, wherein the data stored on the storage media that is located between the read pointer and the write pointer can only be read; and
performing garbage collection on portions of the storage media by advancing the read pointer and re-using the portions of the storage media located before the read pointer and after the write pointer.

2. The method of claim 1, wherein data located logically before the read pointer cannot be read.

3. The method of claim 1, wherein the data stored on the storage media is associated with an expiration policy.

4. The method of claim 3, wherein the expiration policy indicates that the data should only be kept for a pre-determined number of days.

5. The method of claim 1, wherein the data is log data that has the same expiration policy.

6. The method of claim 1, further comprising bringing the read pointer forward to auto-expire the data.

7. The method of claim 6, further comprising:
determining, before bringing the read pointer forward to auto-expire the data, if any data located on the storage media between the read pointer and the write pointer has a hold to prevent auto-expiration of the data; and
copying, when the hold has been detected, the data with the hold to a second storage media before bringing the read pointer forward.

8. The method of claim 1, wherein the storage media is one of a plurality of storage media and the method further comprises selecting a storage media for an incoming write request based on an expiration policy associated with the data and the storage media.

9. A system comprising:
a storage media;
a pointer management module configured to maintain a current write location for a write pointer associated with the storage media and a current read location for a read pointer associated with the storage media;
a data protection module configured to protect data located between the current read location pointer and the current write location pointer; and
a write management module configured to receive write requests, identify the current write location, and write data associated with the write request to the storage media.

10. The system of claim 9, wherein the storage media has a minimum buffer space and the pointer management module is configured to keep the current write location and current read location separated by at least the minimum buffer space.

11. The system of claim 10, wherein the storage media is a flash drive and the minimum buffer space is an erase block of the flash drive.

12. The system of claim 9, further comprising wherein the storage media is a disk drive, a flash drive, a tape drive, a heat-assisted magnetic recording (HAMR) drive, or a patterned media.

13. The system of claim 9, further comprising a holding module to receive a hold request identifying a portion of the data to hold and to copy the portion of data to a second storage media.

14. The system of claim 9, wherein the storage media is one of a plurality of storage media, and the system further comprises a media selection module configured to receive incoming write requests and select the storage media from the plurality of storage media based on an expiration policy.

15. The system of claim 9, wherein the storage media allows for sequential writes and random reads.

16. A method comprising:
storing, in a storage media, log data using sequential writes each starting at a write location identified by a write pointer that is updated to a subsequent location upon completion of each of the sequential writes; and
maintaining a read pointer pointing to a read location on the storage media located before the write pointer to protect a portion of the log data on the storage media by restricting access to the log data located between the read pointer and the write pointer to read only access, and wherein any log data located before the read pointer and after the write pointer is available for garbage collection and new writes.

17. The method of claim 16, wherein the sequential writes are circularly written to the storage media.

18. The method of claim 16, further comprising:
determining a minimum buffer space between the write pointer and the read pointer; and
maintaining the minimum buffer space between the read pointer and the write pointer.

19. The method of claim 16, further comprising:
monitoring for a hold request, wherein the hold request identifies a portion of the log data to be held beyond a current retention policy; and
copying, upon detection of the hold request, the portion of the log data from the storage media to a second storage media or at the write location identified by the write pointer of the storage media.

20. The method of claim 16, wherein the read pointer is advanced upon completion of a retention period for the log data located at the read location.

21. The method of claim 16, wherein the storage media is one of a plurality of storage media and the method further comprises selecting the storage media based on a retention policy of the log data.
